(19) United States
(12) Patent Application Publication
(10) Pub. No.: US 2012/0326060 A1
(43) Pub. Date: Dec. 27, 2012

(54) TESTING METHOD FOR LED WAFER

(76) Inventors: Boaz Kenane, Portland, OR (US); Xiaolan Chen, Tigard, OR (US)

(21) Appl. No.: 13/526,809

(22) Filed: Jun. 19, 2012

Related U.S. Application Data
(60) Provisional application No. 61/500,076, filed on Jun. 22, 2011.

(51) Int. Cl. G01J 1/04

(52) U.S. Cl. 250/578.1

(57) ABSTRACT

The current application is directed to an apparatus and a method for parallel testing and sorting of LED dies on a substrate wafer. The apparatus includes a moving stage and a chuck for the wafer, a wafer prober, collecting and imaging optics, sorting and separating optics, and a linear or rectangular array of light detectors. The method of testing includes moving an LED wafer or a test device on an XY stage, connecting the prober to a line of multiple LED dies or several lines of multiple LED dies, referred to as an “array of devices under test” (“ADUT”), measuring the electrical characteristics of the individual devices under test (“DUT”) in parallel, and collecting light from, and identifying the intensity and wavelength distribution of, the individual DUT in parallel.

### CROSS-REFERENCE TO RELATED APPLICATION

This application claims the benefit of Provisional Application No. 61/500,076, filed Jun. 22, 2011.

### TECHNICAL FIELD

The current application is directed to a testing and sorting apparatus and method for individual LEDs on a manufacturing wafer prior to a dicing step.

### BACKGROUND

The light-emitting diode (“LED”) manufacturing process consists of crystal growth by an epitaxial process, doping and patterning of conducting lines between separate LEDs on substrate wafers, dicing the wafers into individual LEDs, and packaging the LEDs. It is advantageous to test the individual LEDs, referred to as “dies” prior to dicing, while still at the wafer level in order to detect defective dies and to sort the operating dies according to wavelength, intensity and electrical characteristics. The accuracy of measurement of the above-mentioned parameters of the individual dies varies according to the needs of the manufacturer. Usually there is a trade-off between the level of accuracy and the speed of testing. Existing testing apparatuses include probers that apply an electrical current to individual dies and measure their electrical parameters and light-collecting optics, such as an integrating sphere or other large collecting optic, and a sensing device, such as a spectrometer to measure the total luminous flux and the wavelength distribution of each individual die. Usually, the use of an integrating sphere and a spectrometer, alone or concurrently, involves inspecting a single die at a given time, since each die-testing step uses the same integrating sphere or the same spectrometer to test the above-mentioned optical properties. The testing of dies therefore constitutes a serial process, which is slow in nature.

### SUMMARY

The current application is directed to an apparatus and a method for parallel testing and sorting of LED dies on a substrate wafer. The apparatus includes a moving stage and a chuck for the wafer, a wafer prober, collecting and imaging optics, sorting and separating optics, and a linear or rectangular array of light detectors. The method of testing includes moving an LED wafer or a test device on an XY stage, connecting the prober to a line of multiple LED dies or several lines of multiple LED dies, referred to as an “array of devices under test” (“ADUT”), measuring the electrical characteristics of the individual devices under test (“DUT”) in parallel, and collecting light from, and identifying the intensity and wavelength distribution of, the individual DUT in parallel.

### BRIEF DESCRIPTION OF THE DRAWINGS

FIG. 1 is a block diagram of an apparatus and a method for parallel testing and sorting of LED dies on a substrate wafer.

FIGS. 2a-b illustrates an imaging method.

FIGS. 3a-b illustrate a scanning and testing method.

FIGS. 4a-e show the system in a side view, a top view of the detector array, and detection details.

FIGS. 5a-b show an alternative design of the separating optics that uses beam splitters.

FIG. 6 shows another alternative design of the separating optics based on fiber splitting.

### DETAILED DESCRIPTION

### Block Diagram

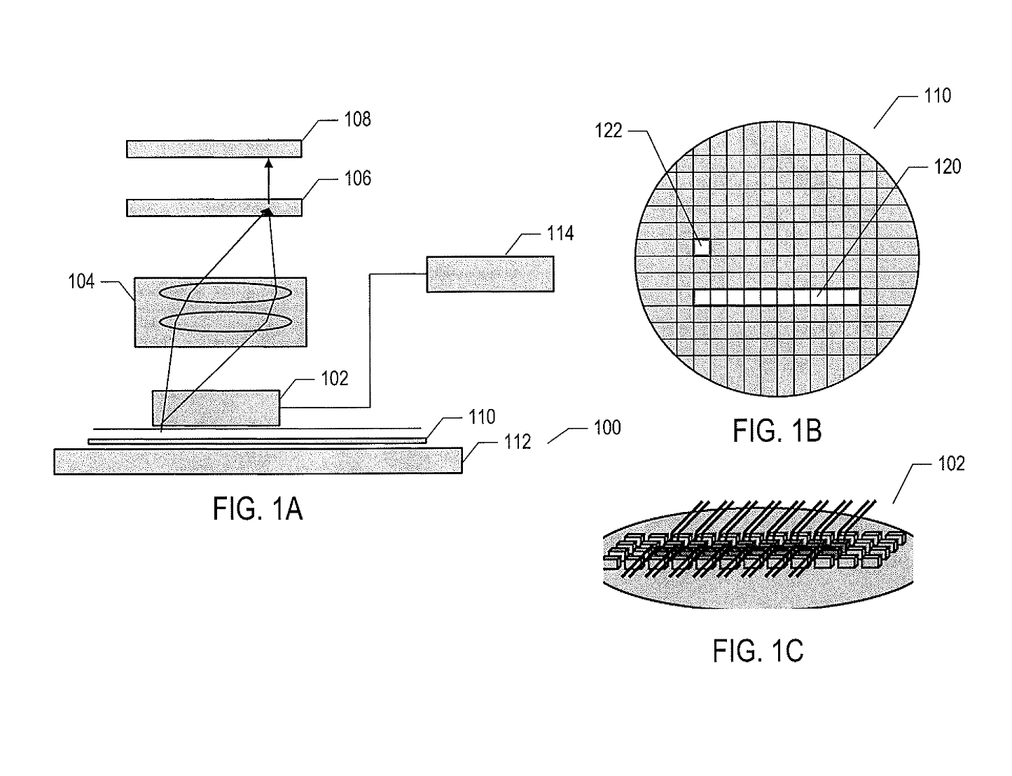

FIG. 1 is a block diagram of an apparatus and a method for parallel testing and sorting of LED dies on a substrate wafer (“currently described instrument” and “currently described method,” respectively). FIG. 1a is a block diagram of the test system. FIG. 1b shows a top view of an LED wafer. The system includes an XY stage 100, a probe card 102, collecting optics 104, separating optics 106, and a split light detector array 108. In this example, the LED wafer 110 is supported on a wafer chuck 112, which is moved by the XY stage. However, alternatively, the wafer can be static and the testing instrument, or part of the testing instrument, can be moved on a stage. In the illustrated example shown if FIG. 1b, the wafer is moved to a position where the probe card can connect to a line of multiple dies or an array of lines of multiple dies comprising an array of devices under test (“ADUT”) 120 of individual devices, such as LED 122. Multiple probe cards are available commercially for on-wafer device testing. This technology is well developed for semiconductor device wafers. The probe card used in one example of the currently described instrument has openings around the individual LEDs to enable the light to go through (see FIG. 1c). Such probe cards are also available in the market. The probe card is connected to an electrical test measurement system 114 that is also available in the market which provides current to the ADUT and, at the same time, measures the electric characteristics of the ADUT while the collecting and separating optics generates an image of the ADUT, on the detector plane, with spatial separation of wavelengths, and the detector array outputs a signal that enables the interpretation of intensity and spectrum of the individual LEDs in the array.

### Imaging

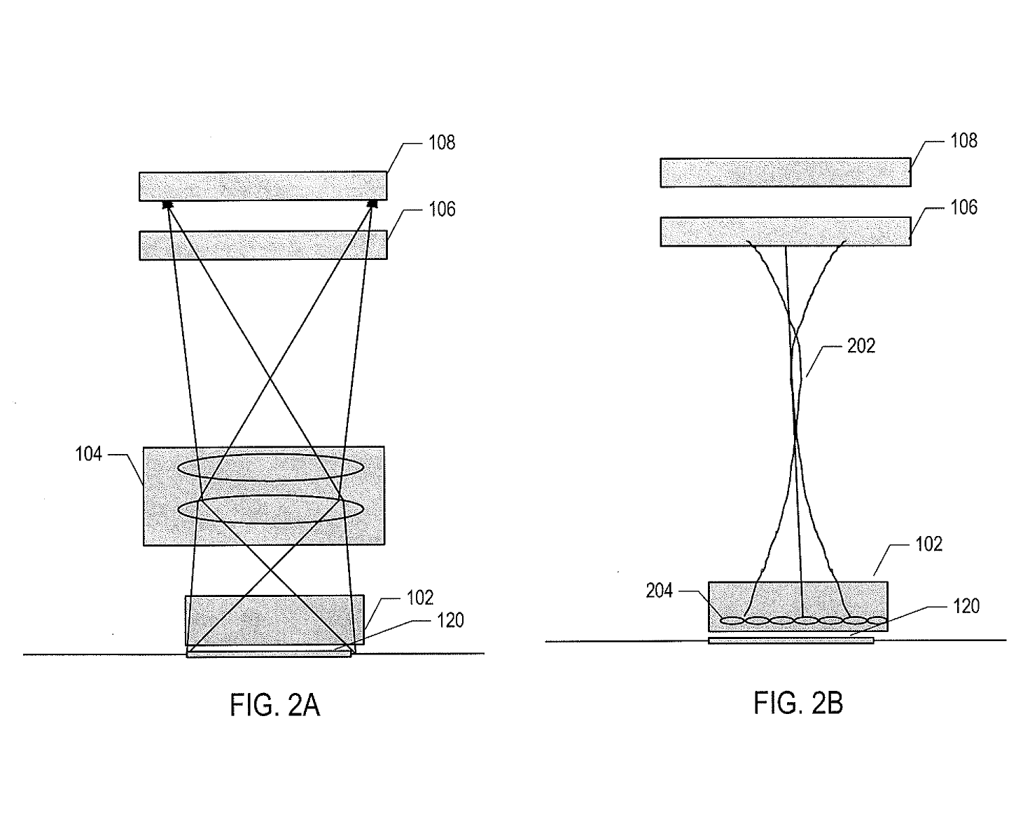

FIGS. 2a-b illustrates an imaging method. In its simplest form, the imaging optics can be a lens assembly 80, as shown in FIG. 2a. The lens images the ADUT 120 on the wafer 110 onto the detector array 108 through the separating optics that are described in more detail in the following paragraphs. The lens can be a zoom-type lens to accommodate variation of the individual die sizes on the LED wafer. The magnification of the zoom lens is set to project each LED onto a corresponding detector or a detector set in the detector array. For example, a typical LED emission dimension can vary between 0.2 mm to 2 mm. Each detector in the detector array can be designed to have dimensions on the order of 0.8 mm and the zoom lens can have a magnification range of 10 (0.25×-2.5×). Zoom lenses with smaller magnification range or even fixed magnification lenses on a lens turret can be used interchangeably to cover the required range of magnification for the different individual die dimensions. FIG. 2b shows another example of an optical system. The alternative example consists of a fiber bundle 202 that is routed from the probe card to the detector array. Each fiber collects light from an individual LED through coupling optics 204 and transmits the collected light to the detector array. The fiber tips and the coupling optics can be integrated onto a specially designed probe card.

### Scanning and Testing Method

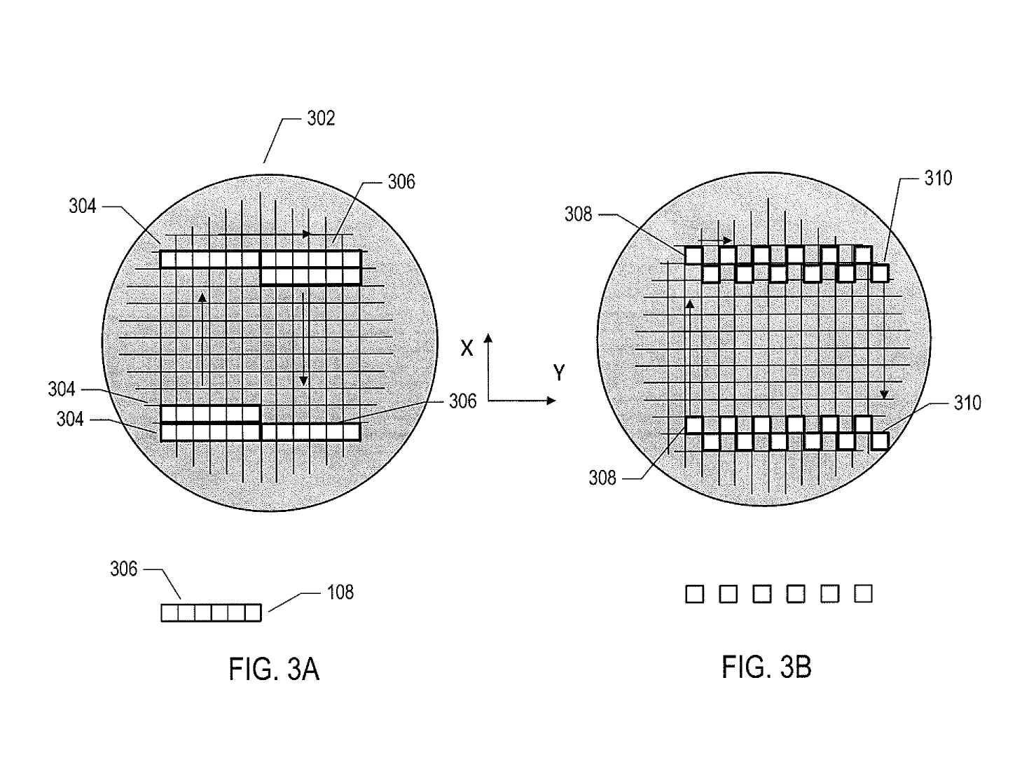

FIGS. 3a-b illustrate a scanning and testing method. A wafer 302 is positioned using the stage with the optical image orientation of the die rows aligned against the detector-array position and orientation. The wafer 302 or the optical head is moved to position X1. The prober comes in contact with the contact points and the LEDs in ADUT 304a are turned on by the prober. Each LED in the ADUT 304a is imaged, using one of the methods described above, by light falling onto one of the detector sets 306 in the detector array 108. The parameters such as intensity and wavelength distribution of all the LEDs in the ADUT are collected and analyzed in parallel, thus considerably accelerating the testing throughput of the currently described instrument compared to other instruments and methods. After the data has been recorded, the wafer 108 or the optical head is moved along the X axis to position X2 and the LEDs in ADUT 304b are tested. The process is repeated until the wafer moves through a full slice and arrives at ADUT 304n. Than the wafer is moved in the Y direction to a 2^{nd} slice, and ADUT 306a through 306n are tested while the wafer moves in the opposite X direction. One of the concerns in LED testing relates to intensity cross talk between different adjacent LEDs. This is the leakage of light from one LED through the optical system to the adjacent LED's detector set. To avoid such cross talk, the ADUT 308b to 308n can be composed of separated LEDs which have one, two, or three device separation lengths between them. The scanning in this case is interlaced. After scanning the entire wafer along the X axis, the wafer (or the measuring instrument) is moved one LED separation distance in the Y direction and the next ADUT (310b to 310n shown in FIG. 3b) is formed and a full X-direction scan is performed again.

### Separating Optics

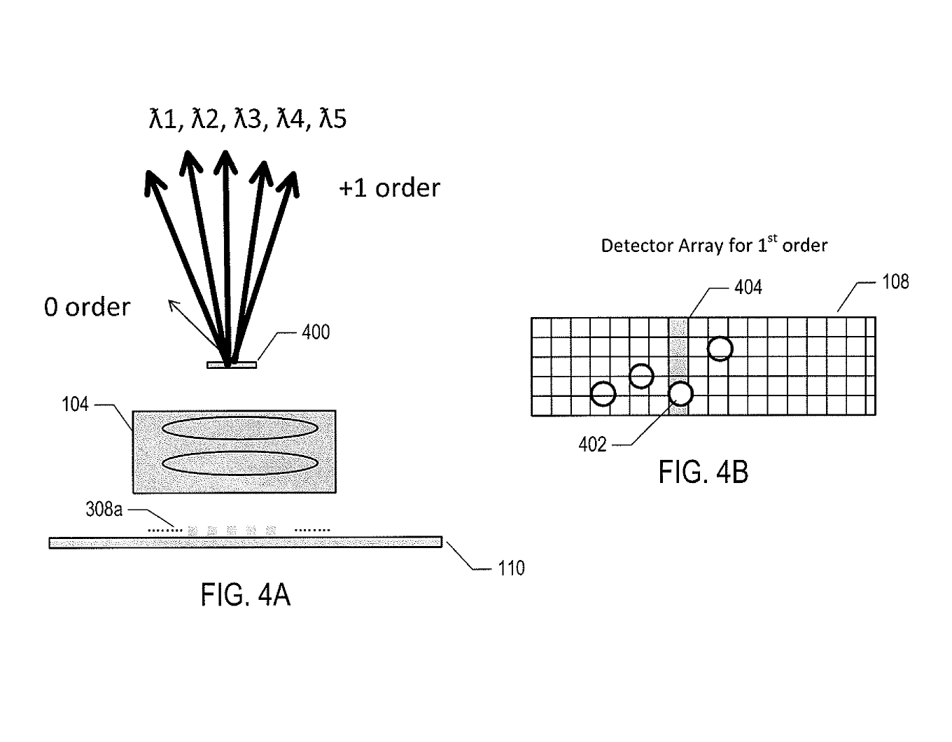

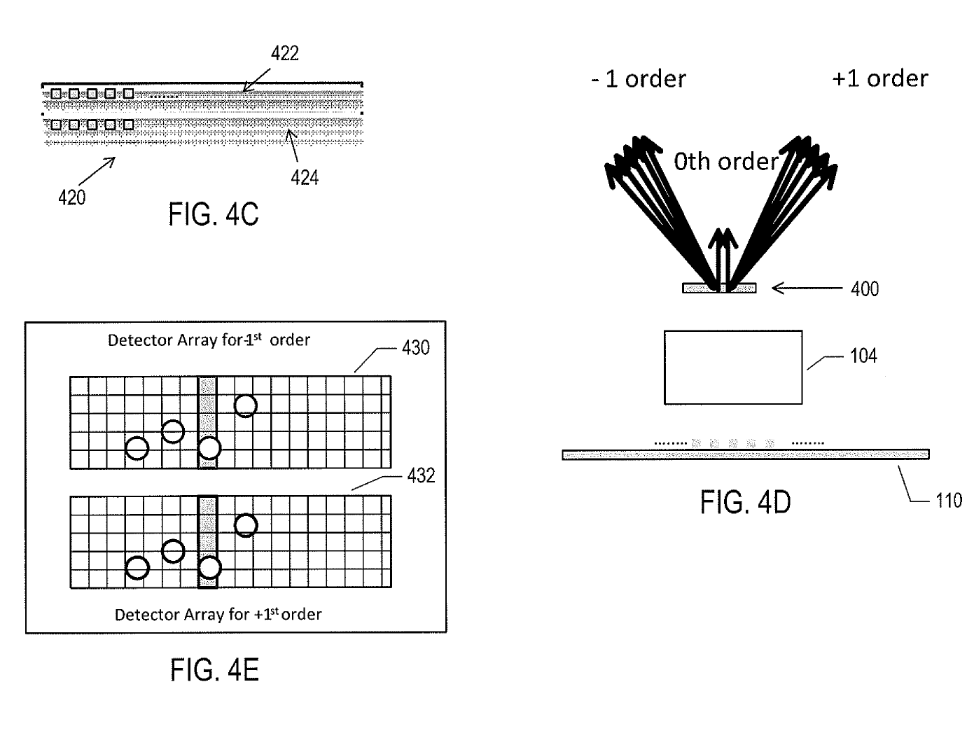

FIGS. 4a-e show the system in a side view, a top view of the detector array, and detection details. FIG. 4a shows the system in a side view, compared to a front view that is shown in FIGS. 1a and 2. FIG. 4b is a top view of the detector array. One possible design for the separating optics is based on a diffraction grating. A custom designed diffractive grating 400 is placed at the image plane of the imaging optics. The grating may be designed to suppress the 0^{th} and −1 order diffraction but enhance the +1 order diffraction. The grating can be designed to direct the +1 order diffraction in a preferred direction, for example, in a direction normal to the grating for λ3. The grating pitch can be selected to avoid 2^{nd} and above order diffraction. The detector array 108 is placed behind the diffractive grating to collect and separate light spots 402 from each die under test on the detector set 404. The distribution of intensity across the detector set can be easily interpreted as the wavelength distribution of the individual LED. An example of a detector array is an area CCD. In this case the detector set is one column of the area CCD. As shown in FIG. 4c, the separating optics in FIG. 4a can also be used to test 2 rows of LED dies simultaneously when the diffractive grating 420 is designed for 2-zone operation. Zone 1 422 is collected to suppress −1th order diffraction and zone 2 424 is collected to suppress the +1th order diffraction. The diffraction direction of the 0^{th} order doesn't need be diverted but the intensity that goes to the 0th order needs be as low as possible. FIG. 4d illustrates the diffraction performance of the diffractive grating 400. An example of a detector array 108 is shown in FIG. 4e. Subarray 430 detects the −1th order diffraction from 422 and subarray 432 detects the +1th order diffraction from 424.

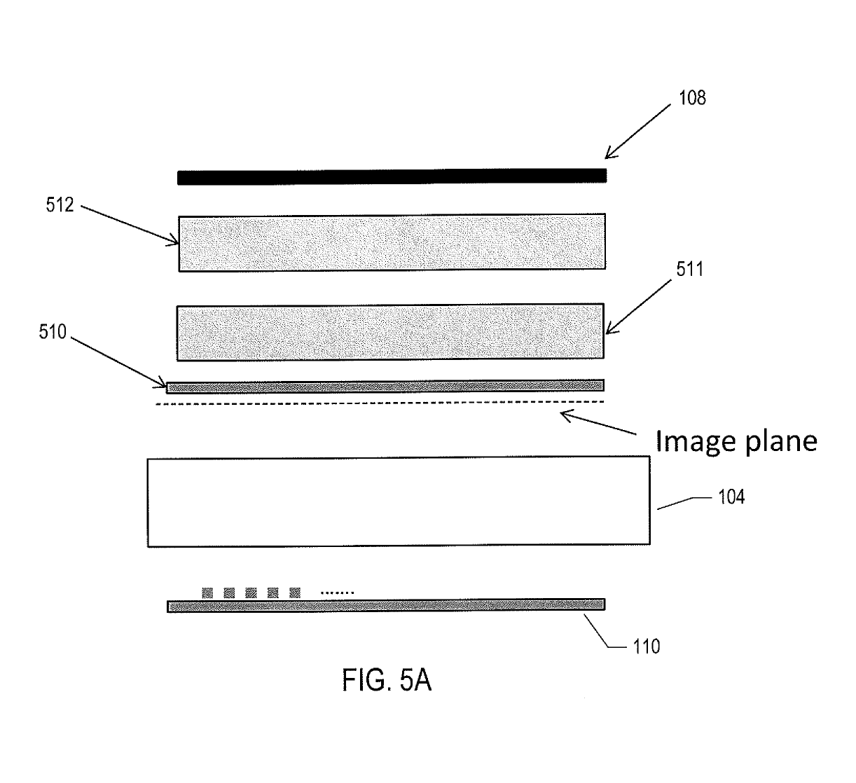

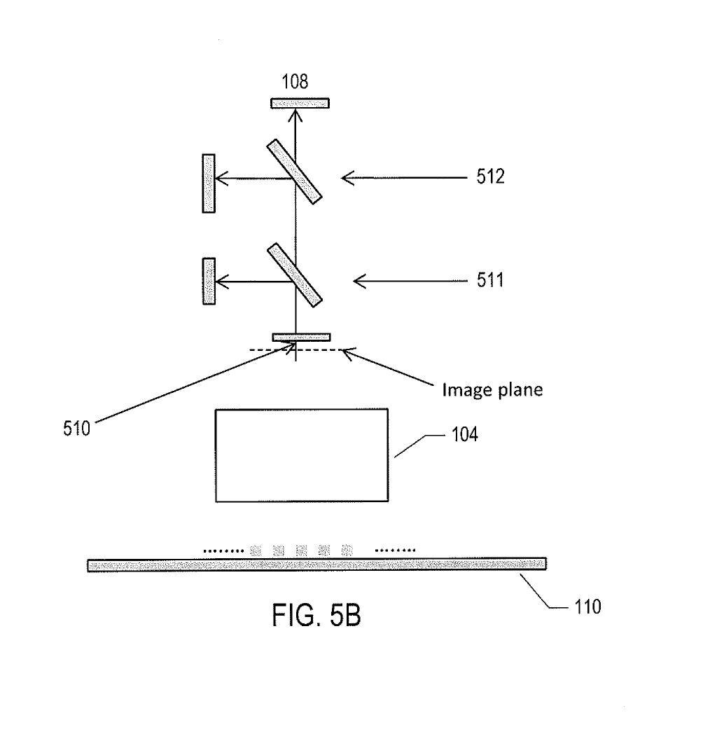

FIGS. 5a-b show an alternative design of the separating optics that uses beam splitters. The beam splitters are used to separate the beam for a 3 binning test. More beam splitters can be added if more than 3 binning is required. Due to the LED's large divergent angle, collimation optics 510 (such as a micro-lens array or zone plate array) needs be placed next to the image plane. There are 2 options for the coating. Beam splitter 1 (511) can be 33/66 and splitter 2 (512) can be 50/50 splitting. Detectors are coated with narrow band passing coating for the 3 wavelength band of interest or filters (not shown) are used. Another option is to coat beam splitter 1 511 and beam splitter 2 512 with a coating to only split the wavelength of interest. Only the 3^{rd} detector is coated with the narrow band pass coating for the 3^{rd} wavelength of interested, in one implementation.

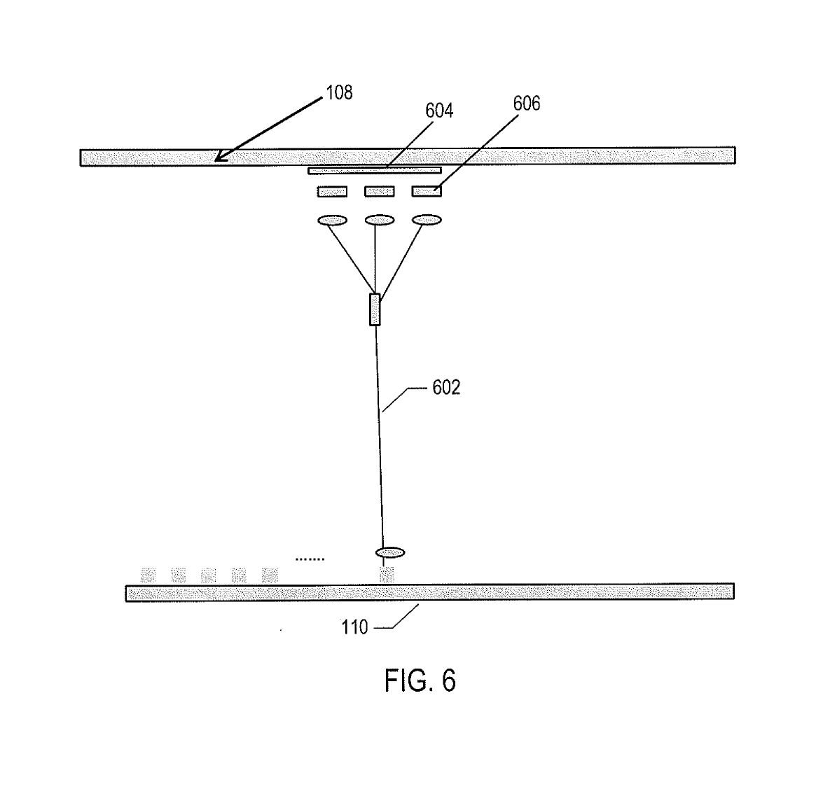

FIG. 6 shows another alternative design of the separating optics based on fiber splitting. In this design, the fiber-imaging method described in the above paragraph is used and the beam splitting is done by splitting each fiber 602 into a number of fibers. A detector set 604 which is part of the detector array 108 is placed at the end of the fibers, one detector at the end of each fiber. Band-pass transmission filters 606 for the specific wavelength of interest are put in front of each detector. The combination of signals from each detector in the detector set can be interpreted to extract the wavelength of the LED that is coupled to the detector set through the split fiber. Coupling optics may need to be used to couple the output of each fiber onto the designated detector in the detector array.

### Compensation and Calibration Method

The light collected by the multiple detectors in the detector array from each individual LED in the array, vary by multiple system parameters, such as detector sensitivity, angular coverage of the optical system at different field points, coupling efficiency of the light into fibers (in the case of using fibers in the collecting optics), optical distortion of the imaging lens (in the case of lens imaging method), variations across the separating optics components, and other factors. The detector array needs to be calibrated one time or periodically, both as a stand-alone component to account for variation inside the detector array and when integrated in the system, to account for system-induced variations. The calibration is done against a known calibrated light source and compensation methods for the variations can include optical alignments of components in the system or electrical signal amplification adjustment or adjustment of the collected signal values by a software algorithm.

1. A LED-wafer analysis system comprising:
a moving stage and a chuck for holding and translating the LED wafer;
a wafer prober that activates a set of LED dies within the LED wafer;
collecting and imaging optics that receive light emitted from the set of activated LED dies;
sorting and separating optics that direct light emitted from each individual activated LED die of the set of activated LED dies and processed by the collecting and imaging optics to a different point in space; and
a linear or rectangular array of light detectors coincident with the points in space to which light emitted from the set of activated LED dies is directed by the sorting and separating optics.
